(19) United States
(12) Patent Application Publication
(10) Pub. No.: US 2014/0358816 A1
(43) Pub. Date: Dec. 4, 2014

(54) Unified Digitization of Company Essentials with Remote Accessibility

(71) Applicant: Curtis Kinsey, Allendale, MI (US)

(72) Inventor: Curtis Kinsey, Allendale, MI (US)

(21) Appl. No.: 14/217,151

(22) Filed: Mar. 17, 2014

Related U.S. Application Data
(60) Provisional application No. 61/802,631, filed on Mar. 16, 2013.

(51) Int. Cl. G06Q 10/10

(52) U.S. Cl. CPC G06Q 10/10
USPC 705/342

(57) ABSTRACT

The present invention is a system that is an online company portal for includes, but is not limited to the following, managing, recording information, prepare reports, prompt sales associates to offer sales to customer, accounting, operations, and sales processes. It may be 100% permission based and remotely securely accessible online via just about any web browser and mobile device.

### PRIORITY AND PRIOR APPLICATIONS

This non-provisional patent application claims priority from provisional patent application No. 61/802,631 filed 16 Mar. 2014.

### FIELD OF THE INVENTION

This invention relates to a Remotely Accessible Permission-Based Employee and Store Management Tracker system, apparatus, and method.

### BACKGROUND OF THE INVENTION

Companies, schools, and people in leadership roles prefer to explore ways to increase employee or student performance, customer satisfaction, address customer needs, and keep employees productive and satisfied with their work.

In addition, companies and other entities may attempt to employ methods to collect and analyze customer satisfaction metrics, in order to determine if current marketing and customer service methods and programs are effective.

Employers may typically attempt to connect all feedback in real time, and then generate an output to employee, store, or service reviews.

Managers of employees have a need to timely receive information and feedback on employee procedures and goals, and whether correct procedures are followed and whether the goals have been reached. And if not, what happened.

There exists a need for a method to track performance of employees and allow the employee to view their performance.

Multiple embodiments of the system are disclosed herein. It will be understood that other objects and purposes of the invention, and variations thereof, will be apparent upon reading the following specification and inspecting the accompanying drawings.

These and other features, aspects and advantages of the present invention will become better understood with reference to the following drawings, description and claims.

### SUMMARY OF THE INVENTION

One aspect of the present invention is a unified digitization of company essentials with remote accessibility system, comprising: a plurality of modules; said module operable with a database having customer information and store information; said module is customizable and said module is operable with said database by a set of parameters that are defined from within an administrator control panel of the system; said parameters allow the system to read from and write to said database; said modules can be selected to launch a certain portal including at least one of the following; an admin control panel, user control panel, reports and trends window, customer capture window, and a customer interaction window; and at least one of said modules that launches a window that prompts the user to qualify a client or customer information; said window has an icons, have different colors as indicators as to whether the user is supposed to offer a specific good or service to the customer.

Another aspect of the present invention is a method of using a unified digitization of company essentials with remote accessibility interface, comprising the steps: logging in; creating a module; linking said module with a database by using a set of parameters that are defined from within an administrator control panel of the system; reading and writing data between a database and a module; and selecting a module that has been operably connected to a database.

A third aspect of the present invention is a unified digitization of company essentials with remote accessibility system, comprising:
a module;
said module operable with a database having at least one of either customer information and store information.

### BRIEF DESCRIPTION OF THE DRAWINGS

FIG. 1 illustrates an embodiment of an admin control window;

FIG. 2 illustrates and embodiment of a user control panel;

FIG. 3 illustrates a reports and trends window;

FIG. 4 illustrates a captured customer window;

FIG. 5 illustrates a customer interaction window;

FIG. 6 illustrates an embodiment of a specific customer window; and

FIG. 7 illustrates an embodiment of the steps involved in using the invention.

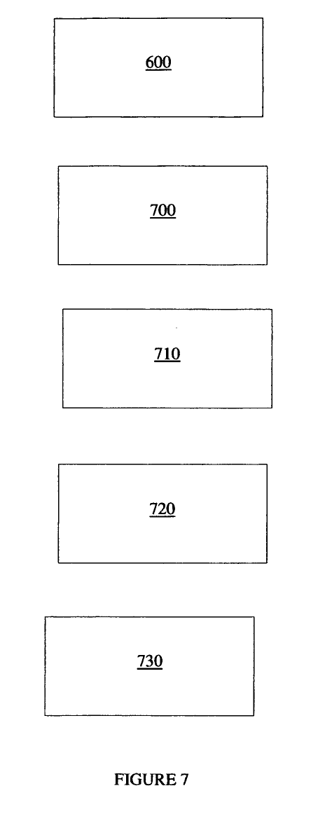

### DETAILED DESCRIPTION OF THE INVENTION

### Reference Numerals

10 system or present invention
20 database
30 interactive device
40 administrative control panel
50 parameter
60 module
70 program
80 reports
90 data
100 general settings
110 custom settings
120 report setting
130 custom module settings
140 portal
150 costumer contact information
160 visit reason
170 interact summary
180 customer capture window
190 contact module
200 service reminder module
210 personal module
220 location module
230 company module
240 customer interaction window
250 icon
260 company reports
270 employee reports
280 product reports
290 location reports
300 customer
310 user control panel window
320 general settings
330 report settings
340 customer settings
350 custom module settings
370 global module
380 user and location module
390 costumer module
400 product module
410 marketing module
420 report module
430 customer information
440 store information
500 interface
510 offing a product or service
600 logging in
700 selecting a module

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

The present invention may be a system that is an online company portal intended and projected to replace just about everything you can think of from accounting, operations, sales processes, etc. It may be 100% permission or title based and thus have access restriction and remotely securely accessible online via just about any web browser and mobile device, such as a phone, tablet, or computer, also referred to as an interactive device 30.

The system is unique in a lot of aspects, but helps keep employees, stores, and all information unified into a single place and log-in.

Base purpose of the present invention 10 may be to unify and keep linked or updated throughout all systems employees and stores and their information, which also improves accountability.

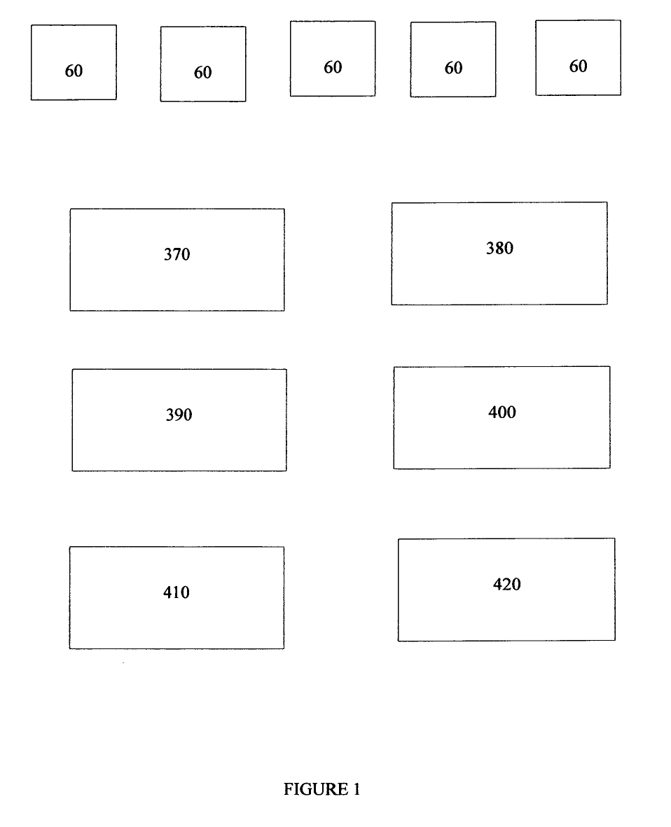

In one embodiment, modules 60 may be disposed along the top of the screen, as seen in FIG. 1. The module 60 can be selected to launch a certain portal 140. A portal 140 includes an admin control panel 40, user control panel 310, reports and trends window 450, customer capture window 180, or a customer interaction window 240.

The modules 60 can be modified by a user based on permission settings. For example the administrator may be the only user authorized to add or modify modules 60.

A module 10 can be used to interface with the user. Modules may be added, deleted, and modified, thereby making the module 10 customizable.

A module 10 may be operable with a database 20. For example the present invention 10 can read and write to a RQ4 database. The company or user or administrator can define all products and services in such a database 20. This means that if a user activates a module 60 by, for example, clicking it on a table, phone, or with a computer mouse, the selected module 10 can pull data from any existing database 20 or program 70. Thus anyone using the system 10 does not have to replace any other program. There may be more then one database 20, and it is expected that many databases would be used with the present invention 10. One database 20 customer information 430, while another database may have store information 440, or information about the company such as employees and different store locations.

The present invention 10 is thus ready to adopt any function of a business as a module 60 or portal 140. For example, someone can replace a point of sale program and add it as a module 60 or portal 140.

The present invention 10 is made operable with a database 20 by a set of parameters 50 that are defined from within an administrator control panel 40 of the system (10);
said parameters (50) allow the system (10) to read from and write to said database (20).

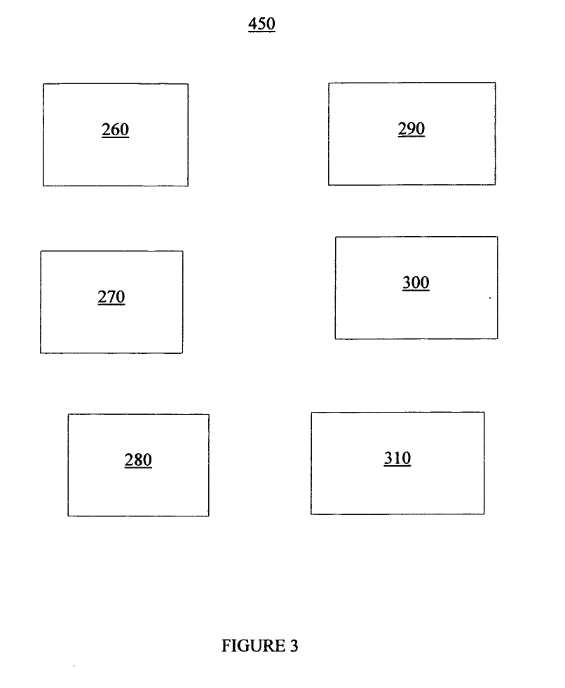

As seen in FIG. 3, one module 60 may be selected to access and launch a reports and trends portal 450. This may contain information regarding trends and reports, such as company reports, such as company performance, sales, trend, and grade. The user can set the system to automatically send custom company reports through e-mail and messaging on a defined periodic schedule, including raw data, images, and graphs.

The same or a different module, depending on administrator preference may access location reports, such as location performance, sales, trend and grade. The user can set the system to automatically send custom company reports through e-mail and messaging on a defined periodic schedule, including raw data, images, and graphs.

There may be a plurality of modules 10. In one embodiment the modules 10 may be disposed horizontally along the top of a website.

In one embodiment an administrator or other with proper rank may also be assigned via an administrator control panel 40, and can on-the-fly add, remove, modify anything, including: modules, users, customers, and products from directly within the relevant windows of the present invention 10.

Additionally, the present invention 10 may be designed as such that anything and everything can be achieved through a simple drag n drop, or point and click, interface from within the master admin control panel 40. This includes everything from add, create, delete, modify, to automation. Automation may include but not be limited to auto reports on intervals, auto text/email, etc.

During the modification or creation process of a module 60, the appearance of certain links, features, and functions are set per user or group. For example all employees can generate a self grading sales report from within a user control panel 310. This is the same for anything and everything. Where these “links” to said functions appear is completely up to the user or owner or company, thus completely customizable, for example, one company may not have a user control panel. The user includes the owner and company.

The user may control settings to have the present invention send hourly automated reports of location and employee grades.

Another embodiment of the present invention 10 may allow a user to add the ability to run a point of sale as a module within the present invention 10.

The present invention 10 may have complete integration with the user's databases 20 and other complete integration meaning that a user can directly read/import from any and all existing database(s) 20 and data 90. For example, the user may pull their existing customers from a point A in the database 20, their existing products from point B in the database 20, and their employees from point C in the database 20. All data 90 will then be fed and imported into the present invention 10 seamlessly and ready to use.

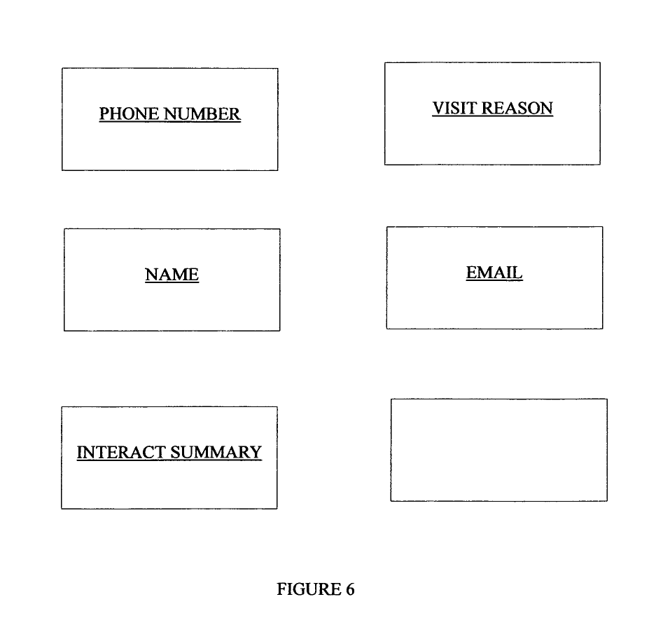

Customer information and data 90 may be entered in a portal, interface, or website as illustrated in FIG. 6. This portal 140 may have customer name and contact information, 150, visit reason 160, interact summary 170. This portal 140 may have other prompts to illustrate what products or services were offered, which products or services were sold, and other information.

Another portal 140 may be an end of the day checklist so the employee would review before leaving work (not illustrated).

Another portal 140 may be a live scoreboard showing company numbers for a certain time period.

Per above example, the constant and automated pulling and importing of said data 90 can be defined. This would permit a user or user's employer to continue using existing systems and programs with the present invention 10.

The present invention 10 may be built for the unlimited addition of functions and features defined as modules 60 that launch portals 140 or windows 140. The portals 140 may have links a data 90 stored on a database 20. This means that the present invention 10 can handle for example product ordering, point of sale (checkout), and anything else the company desires. These features are not required, but optional. Some companies may not like the idea of replacing entire systems.

Clicking another module 60 may launch an admin control panel or window 40 as seen in FIG. 1. The admin control window 40 may have a global module 370, user location module 380, customer module 390, product module 400, marketing module 410, and a report module 420.

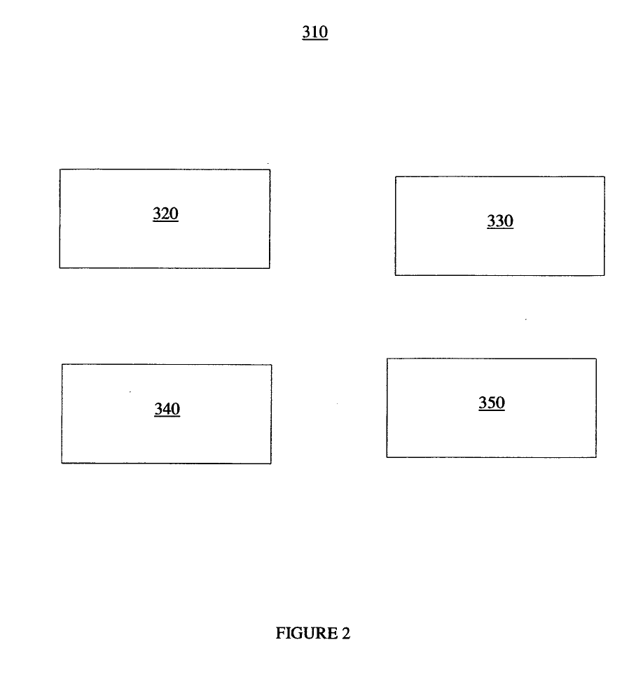

Clicking another module 60 may launch a user control panel window 310 as illustrated in FIG. 2. The user control panel window 310 may have a general settings 320, report settings 330, customer settings 340, and custom module settings 350.

The report settings 330 allow a user the capability to schedule automated reports and these reports can be emailed to a predetermined set of contacts or addresses.

The general settings 320 may include the user information, the store information, time and date format, and themes.

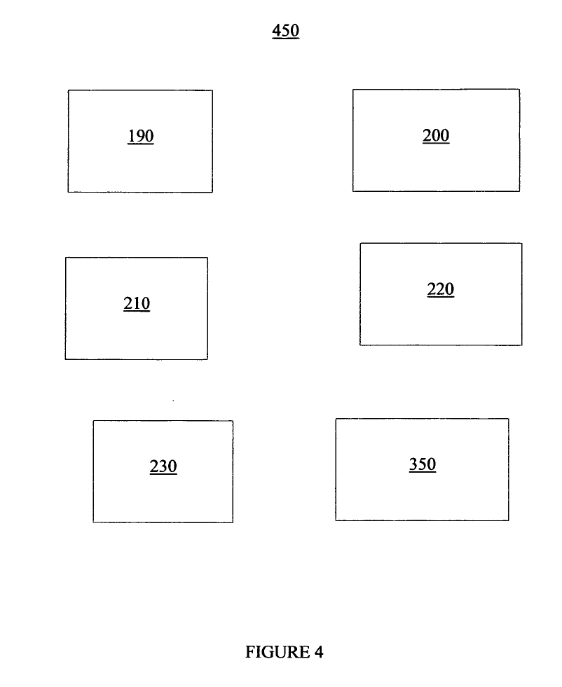

As seen in FIG. 4, clicking another module 60 can open up a captured customer window 180, having a contact list module 190, service reminder module 200, a personal module 210 to manage user specific customer access and management, to allow the user to access lists, managing user notes, orders, requests, and to execute automated or non-automated customer specific tasks.

This captured customer window 180 may also have a location module 220. This location module 220 may have location specific customer, store, or employer information. For example, if a company had several different locations, the location module 220 would be used to find information on different store locations.

This captured customer window 180 may also have a company module 230, which provide the user to company wide information.

Depending on the type of company, a custom module 350 could be added.

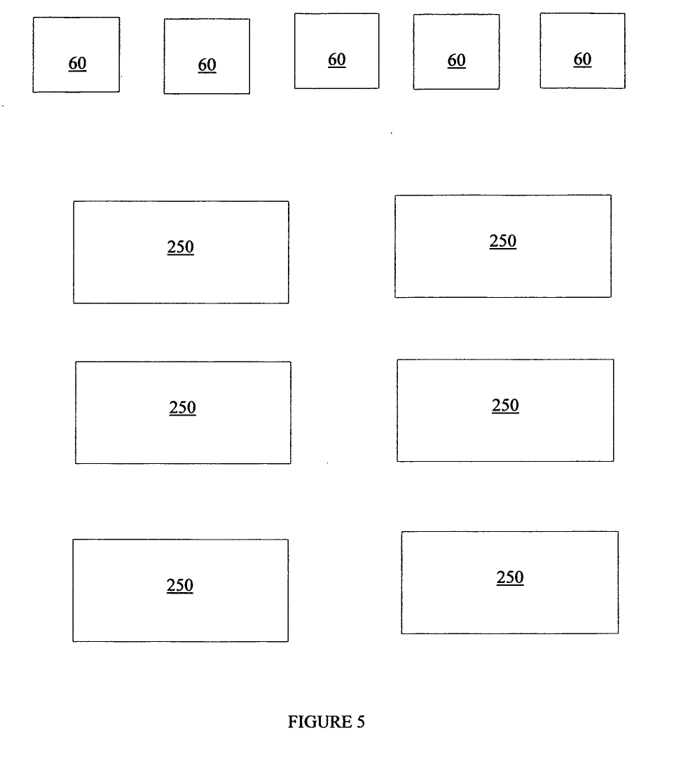

FIG. 5 illustrates a customer interaction window 240. This specific customer interaction window 240 has costumer information such as name and contact information, and icons such as bags 250, that may prompt the user to offer products or services to the customer. The icons 250 may have different colors as indicators. For example, a red icon 250 may indicate that a certain product was offered and rejected; a green icon 250 may indicate that a product was offered and sold; a yellow indicator would indicate that a product is recommended for the customer, prompting the user to offer that service to the customer.

One module may prompt the use to qualify a client or customer. The system 10 may prompt the user with certain questions to ask the customer, such as, offering a product or service 510, and then the user can enter information such as (1) whether the product of service was offered by the user to the customer; (2) if the customer purchased the product or service, or (3) if the customer declined the product or service; and any other relevant information. All of this data 90 would be recorded and stored. The next time that the user would engage with the customer, all of this data 90 is available for the user to see or otherwise access. A blind user would also have access through either audio or brail.

Regardless the route chosen by the company, complete, seamless, and most importantly, automated integration of any and all data and databases is guaranteed here.

The present invention 10 will allow employees to enforce accountability, does not add time to record or use the data 90.

The present invention 10 can replace a point of sale system or a customer management relationship (CRM) program.

I claim:

1. A unified digitization of company essentials with remote accessibility system (10), comprising:
a module (60);
said module (60) operable with a database (20) having customer information (430) and store information (440).

2. The system (10) of claim 1, wherein said module (60) is customizable.

3. The system (10) of claim 1, wherein said module (60) is operable with said database (20) by a set of parameters (50) that are defined from within an administrator control panel (40) of the system (10);
said parameters (50) allow the system (10) to read from and write to said database (20).

4. The system (10) of claim 1, whereby there are a plurality of said modules (60), and said modules (60) can be selected to launch a certain portal (140) including at least one of the following; an admin control panel 40, user control panel 310, reports and trends window 450, customer capture window 180, and a customer interaction window 240.

5. The system (10) of claim 1, wherein the system (10) is a website.

6. The system (10) of claim 1, wherein the system (10) is a computer program.

7. The system (10) of claim 1, wherein said module (60) prompts a user to ask a customer a series of questions.

8. The system (10) of claim 1, further comprising a module (60) that launches a window that prompts the user to qualify a client or customer information; said window has an icons (250), have different colors as indicators as to whether the user is supposed to offer a specific good or service to the customer.

9. A method of using a unified digitization of company essentials with remote accessibility interface, comprising the steps:
logging in (600);
creating a module (700);
linking said module with a database by using a set of parameters that are defined from within an administrator control panel of the system (710);
reading and writing data between a database and a module (720); and
selecting a module that has been operably connected to a database (700).

10. The method of claim 9, further comprising the step of offering to sell something to customer.

11. A unified digitization of company essentials with remote accessibility system (10), comprising:
a plurality of modules (60);
said module (60) operable with a database (20) having customer information (430) and store information (440);
said module (60) is customizable and said module (60) is operable with said database (20) by a set of parameters (50) that are defined from within an administrator control panel (40) of the system (10);
said parameters (50) allow the system (10) to read from and write to said database (20);
said modules (60) can be selected to launch a certain portal (140) including at least one of the following; an admin control panel 40, user control panel 310, reports and trends window 450, customer capture window 180, and a customer interaction window 240; and
at least one of said modules (60) that launches a window that prompts the user to qualify a client or customer information; said window has an icons (250), have different colors as indicators as to whether the user is supposed to offer a specific good or service to the customer.
